(19) United States
(12) Patent Application Publication
(10) Pub. No.: US 2026/0315956 A1
(43) Pub. Date: Oct. 15, 2026

(54) MOBILE LIQUID CONTAMINATE SEPARATOR

(71) Applicant: Solidification Products International, Inc., Northford, CT (US)

(72) Inventors: Samuel Bourseul, Northford, CT (US); William Gannon, Northford, CT (US)

(21) Appl. No.: 19/485,091

(22) PCT Filed: Jul. 28, 2023
(86) PCT No.: PCT/US2023/028993

§ 371 Date: Nov. 17, 2025

(51) Int. Cl. B01D 15/00; C02F 1/28; C02F 101/32

(52) U.S. Cl. CPC B01D 15/00; C02F 1/28; C02F 2101/32; C02F 2201/004; C02F 2201/007; C02F 2201/008

(57) ABSTRACT

A mobile liquid separator device and method for removing hydrocarbon-based contaminates from a contaminated liquid source. The device comprises a vessel housing having a base with vertically upstanding sidewalls forming an interior sump, a liquid inlet port, a liquid return port, and a filtration port. The liquid inlet port, liquid return port, and filtration port are disposed on at least one of the vertically upstanding sidewalls and in communication with the interior sump. A bracket assembly is coupled to the vessel housing and includes a telescoping bracket subassembly moveable between a retracted position and an extended position, cantilevered from the vessel housing.

### BACKGROUND OF THE INVENTION

### 1. Field of the Invention

This invention relates to an apparatus for and method of treating hydrocarbon contaminated liquid sources utilizing a hydrocarbon absorption/adsorption media, and more particularly to a mobile apparatus and method of treating hydrocarbon contaminated liquid sources in low laying locations.

### 2. Description of the Related Art

In many regions around the world, electrical utilities have some form of underground networks—generally, underground manholes and vaults—which house energized equipment and/or serve as cable troughs. These locations are susceptible to flooding, resulting in contaminated liquid sources which are in need of not only drainage but treatment in cases where the contaminates are environmentally hazardous.

The logistics of the drainage and treatment of these flooded regions is problematic and expensive. Often, these underground vaults are in locations which make it difficult to bring in drainage equipment to the work site. Further, government municipalities in some locations lack small to medium scale liquid treatment capabilities, requiring outsourcing to other agencies which results in further expense. Thus, a need exists in the industry for a drainage and treatment device which can mitigate these difficulties.

### SUMMARY OF THE INVENTION

Bearing in mind the problems and deficiencies of the prior art, it is therefore an object of the present invention to provide an apparatus for and method of treating hydrocarbon contaminated liquid sources which can be used in locations with a limited area footprint.

It is another object of the present invention to provide an apparatus for and method of treating hydrocarbon contaminated liquid sources which can be readily moved without lifting equipment.

A further object of the present invention is to provide an apparatus for and method of treating hydrocarbon contaminated liquid sources which can be readily stored when not in use.

It is another object of the present invention to provide an apparatus for and method of treating hydrocarbon contaminated liquid sources which is located in a low laying location.

Still other objects and advantages of the invention will in part be obvious and will in part be apparent from the specification.

The above and other objects, which will be apparent to those skilled in the art, are achieved in the present invention which is directed to a mobile liquid separator device for removing hydrocarbon-based contaminates from a contaminated liquid source. The device comprises a vessel housing comprising a base with vertically upstanding sidewalls forming an interior sump, a liquid inlet port, a liquid return port, and a filtration port. The liquid inlet port may be disposed on one of the vertically upstanding sidewalls and in communication with the interior sump, the liquid return port may be disposed on one of the vertically upstanding sidewalls and in communication with the interior sump, and the filtration port may be disposed on one of the vertically upstanding sidewalls and in communication with the interior sump. A bracket assembly may be coupled to the vessel proximate the base and includes a telescoping bracket subassembly moveable between a retracted position wherein a length portion of the telescoping bracket subassembly is within an interior of the bracket assembly to an extended position wherein the length portion of the telescoping bracket subassembly is exterior to the bracket assembly and cantilevered from the vessel housing.

In some embodiments, the device comprises a removable filter component in communication with the filtration port, the removable filter component housing an adsorbing/absorbing filtration media capable of removing hydrocarbon-based contaminates from a contaminated liquid source, and allowing egress of a purified portion of the contaminated liquid source to the exterior of the device. The filtration port may comprise a plurality of filtration ports and wherein the removeable filter component comprises a plurality of removable filter components, each of the plurality of removable filter components in communication with one of the plurality of filtration ports. The plurality of filtration ports may be arranged in a 3-row by 2-column matrix on a sidewall surface of the vessel housing. The filtration port may include a valve and a removably attachable filter interconnect, the removably attachable filter interconnect for removeable engagement with a filter component.

The vessel housing interior sump may include a debris housing in fluid communication with the filtration port. The debris housing may include a pump capable of establishing a siphon for transport of a contaminated liquid into the interior sump. The filtration port may be oriented at an angle of 15-degrees to 25-degrees below horizontal to facilitate gravity flow of liquid egressing the interior sump. The vessel housing may include a non-opaque liquid level indicator.

The bracket assembly may include a plurality of telescoping bracket subassemblies. The bracket assembly may comprise a plurality of vertical and horizontal framework providing an elevated platform for the vessel housing. The telescoping bracket subassembly may include a resilient grasping element. The device may include a plurality of bracket assemblies, or a liquid transport tube secured to the liquid inlet port and the liquid return port, the liquid transport tube in fluid communication with a hydrocarbon contaminated liquid source in a location below the vessel housing.

The present invention also provides a method of removing hydrocarbon-based contaminates from a contaminated liquid source. The method comprises the steps of transporting a mobile separator device from a stowed location to a selected work site proximate a contaminated liquid source; and securing liquid transport tubes to a liquid inlet port and a liquid return port of the mobile separator device to establish fluid communication of the contaminated liquid source with an interior sump of the mobile separator device. After establishing a siphon action within the liquid transport tube, the contaminated liquid source will ingress the interior sump. The method further comprises establishing fluid communication with a filtration port and/or a removable filter component of the mobile separator device for selective liquid removal of the contaminated liquid source to the mobile separator device exterior.

In one or more embodiments, the method comprises the steps of moving a telescoping bracket subassembly of a bracket assembly coupled to the mobile separator device from a retracted position wherein a length portion of the telescoping bracket subassembly is within an interior of the bracket assembly to an extended position wherein the length portion of the telescoping bracket subassembly is exterior to the bracket assembly and cantilevered from the mobile separator device. The method may also comprise removing the removable filter component from the interior sump; and securing the removable filter component to the filtration port via a removably attachable filter interconnect.

The method may further comprise the steps of preventing the ingress of liquid to the filtration port; disengaging the filter component from the filtration port; securing a second removable filter component to the filtration port via the removably attachable filter interconnect; and allowing the ingress of liquid to the filtration port. The mobile separator device may be transported to a selected work site using labor force. The removable filter component may house an adsorbing/absorbing filtration media capable of removing hydrocarbon-based contaminates from the contaminated liquid source, and allows the egress of a purified portion of the contaminated liquid source to the mobile separator device exterior.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a perspective view of a mobile liquid contaminate separator according to one embodiment of the present invention, with internal features shown in broken lines;

FIG. 2 depicts a front elevation view of a mobile liquid contaminate separator according to one embodiment of the present invention, with internal features shown in broken lines;

FIG. 3 depicts a side perspective view of a mobile liquid contaminate separator according to one embodiment of the present invention, with internal features shown in broken lines;

FIG. 4 depicts a top plan view of a mobile liquid contaminate separator according to one embodiment of the present invention;

FIG. 5 depicts a side perspective view of a mobile liquid contaminate separator according to one embodiment of the present invention, with internal features shown in broken lines;

FIG. 6 depicts a side elevation view of a mobile liquid contaminate separator according to one embodiment of the present invention, with internal features shown in broken lines;

FIG. 7 depicts a front elevation view of a mobile liquid contaminate separator according to one embodiment of the present invention, with internal features shown in broken lines;

FIG. 8 depicts a side elevation view of a mobile liquid contaminate separator according to one embodiment of the present invention;

FIG. 9 depicts a perspective view of a mobile liquid contaminate separator according to one embodiment of the present invention, with internal features shown in broken lines;

FIG. 10 depicts a perspective view of a mobile liquid contaminate separator according to one embodiment of the present invention, with internal features shown in broken lines;

FIG. 11 depicts a side elevation view of a mobile liquid contaminate separator according to one embodiment of the present invention; and

FIG. 12 depicts a flow diagram of an example method for the removal of hydrocarbon-based contaminates from a contaminated liquid source according to one embodiment of the present invention.

### DESCRIPTION OF THE EMBODIMENT(S)

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc., may be used herein to describe various components, these components should not be limited by these terms. These terms are only used to distinguish one component from another. For example, a first element could be termed a second element, and, similarly, a second element could be termed a first element, without departing from the scope of the present invention. As used herein, the singular forms “a”, “an” and “the” are intended to include the plural forms as well, unless the context clearly indicates otherwise. Also, as used herein, the term “and/or” includes any and all combinations of one or more of the associated listed items. It will be further understood that the terms “include” and/or “including” when used herein, specify the presence of stated features, steps, operations, elements, and/or components, but do not preclude the presence or addition of one or more other features, steps, operations, elements, components, and/or groups thereof.

Relative terms such as “below,” “above,” “upper,” “lower,” “horizontal,” “vertical,” “top,” “bottom,” “rear,” “front,” “side,” or the like may be used herein to describe a relationship of one element or component to another element or component as illustrated in the figures. It will be understood that these terms are intended to encompass different orientations of the device in addition to the orientation depicted in the figures.

Additionally, in the subject description, the words “exemplary,” “illustrative,” or the like are used to mean serving as an example, instance or illustration. Any aspect or design described herein as “exemplary” or “illustrative” is not necessarily intended to be construed as preferred or advantageous over other aspects or design. Rather, use of the words “exemplary” or “illustrative” is merely intended to present concepts in a concrete fashion.

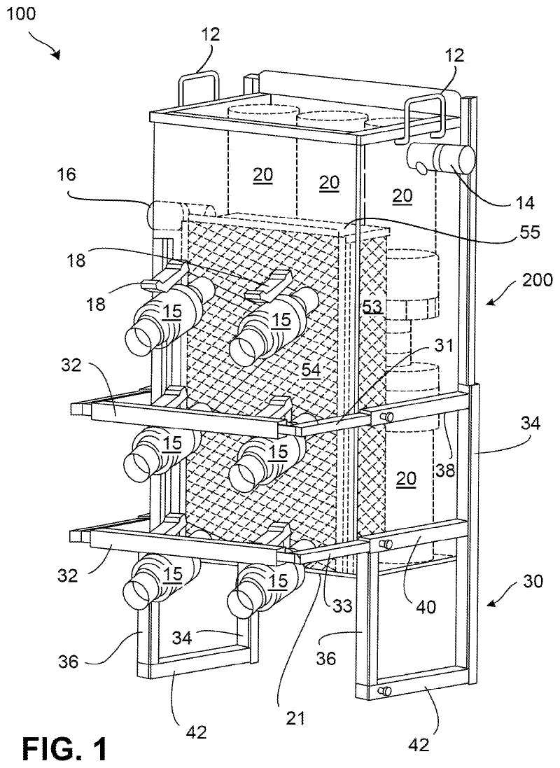

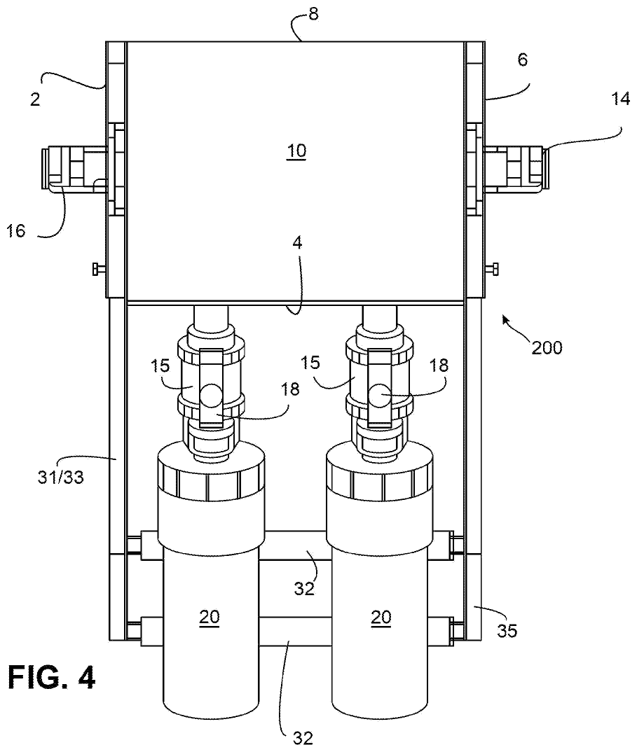

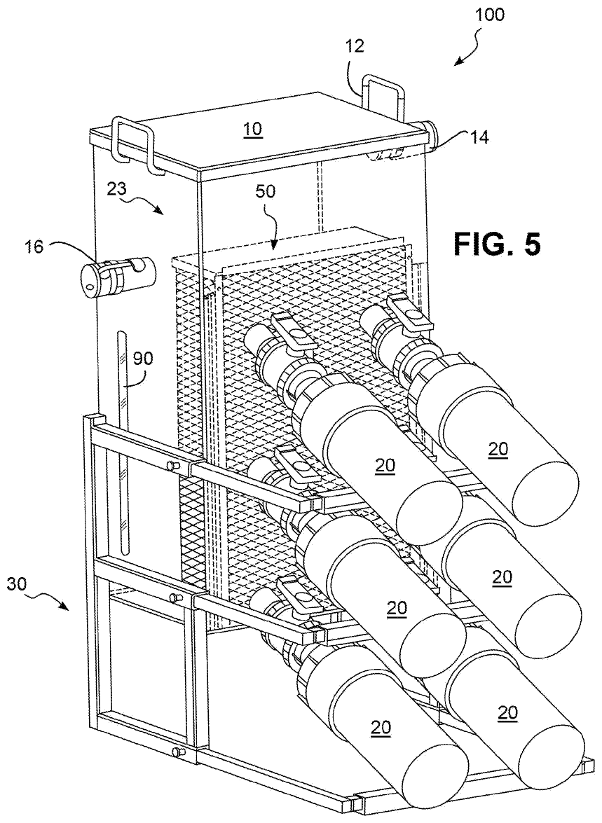

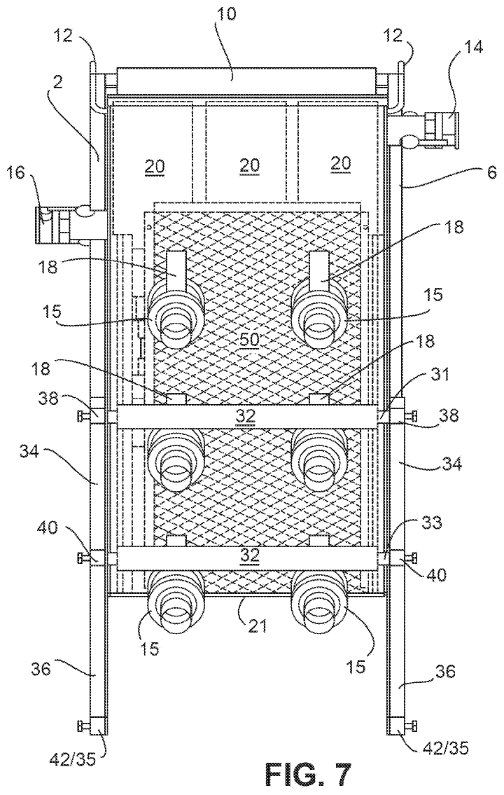

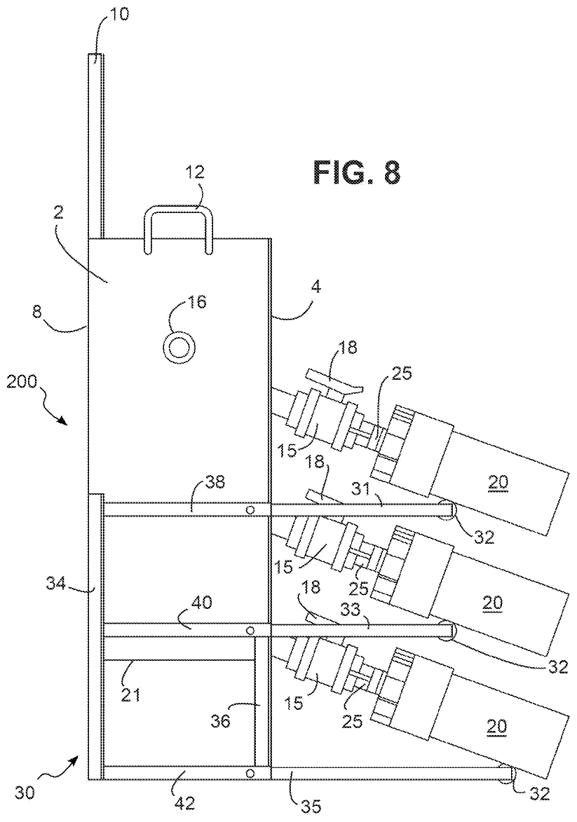

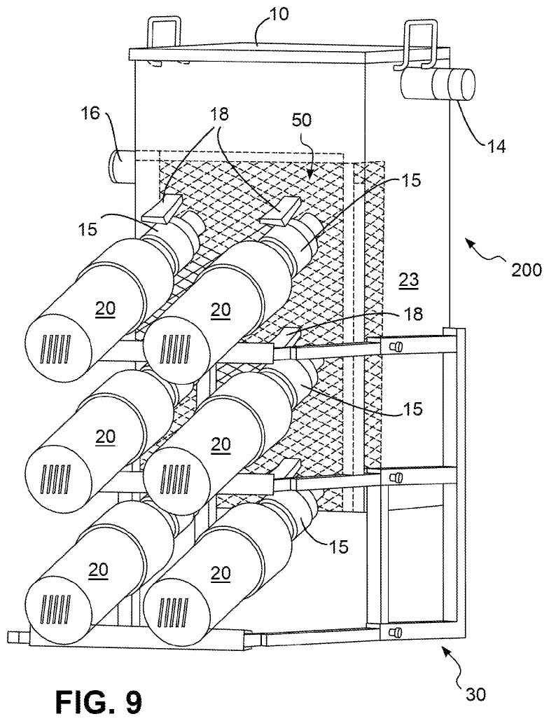

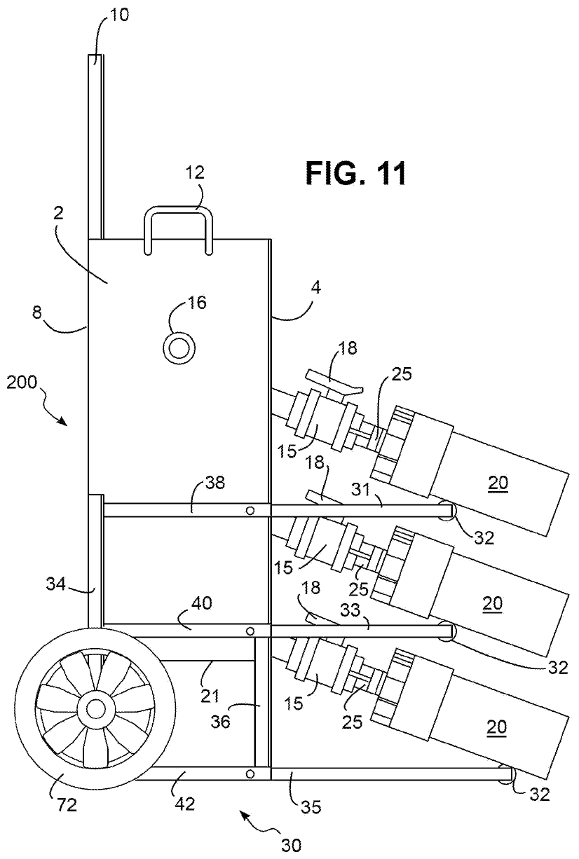

In describing the embodiment of the present invention, reference will be made herein to FIGS. 1-12 of the drawings in which like numerals refer to like features of the invention.

The present invention provides a mobile apparatus for and method of treating hydrocarbon contaminated liquid sources in low laying locations with a limited area footprint, and can be readily stored and moved without specialized lifting equipment. The apparatus comprises a vessel housing for the introduction of a contaminated liquid source, which can be subsequently purified via a removeable and replaceable filter component in communication with a filtration port to the vessel exterior. When placed in the stowed position, the mobile separator device encompasses a significantly decreased footprint, allowing a small, compact device which can be used in situations to employ a rapid response to low laying locations.

FIGS. 1-11 depict a mobile liquid contaminate separator according to one or more embodiments of the present invention. The mobile separator device 100 comprises a vessel housing 200 elevated by a bracket assembly 30 and includes one or more liquid filtration ports 15 in communication with the vessel housing interior sump 23 and one or more removable filter components 20. The vessel housing 200 includes a liquid inlet port 14 and a liquid return port 16 in communication with the interior sump 23.

During operation of the device, liquid transport tubes (not shown) are secured to the liquid inlet port 14 and liquid return port 16, placing the interior sump 23 in fluid communication with a hydrocarbon contaminated liquid source that is preferably in a low lying location, such as a subterranean liquid source, a surface liquid source, and the like. Upon establishing a siphoning action within the liquid transport tube, the contaminated liquid source will ingress the vessel housing interior sump via inlet port 14, filling interior sump 23. As the volume of contaminated liquid increases within the interior sump 23, contaminated liquid will begin to communicate with the vessel housing filtration port(s) 15, such that contaminated liquid will enter filter component(s) 20, for selective liquid source removal to the device exterior.

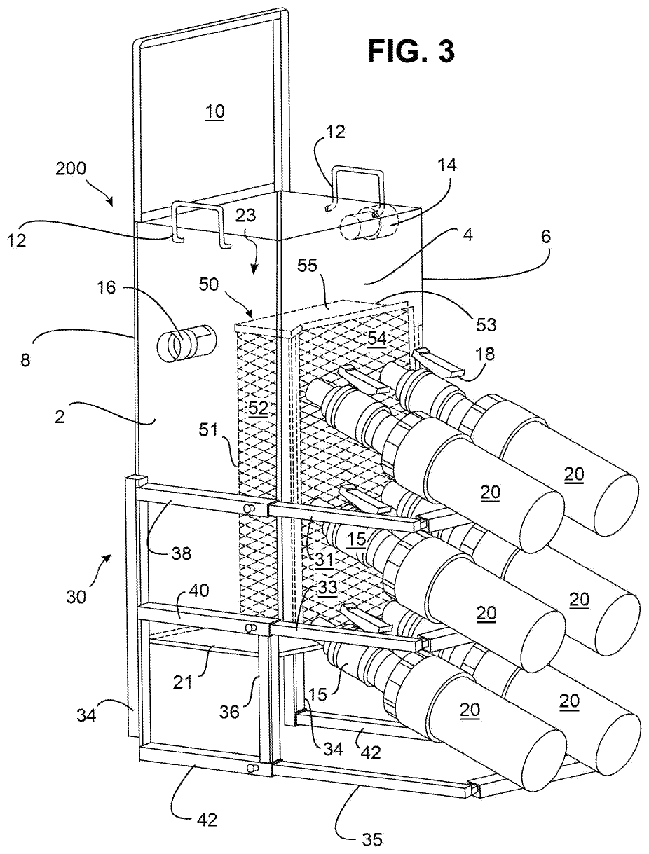

As depicted in FIG. 1, the device 100 is in a stowed position wherein the filter component(s) 20 are stored within the interior sump, further increasing the overall modularity and mobility of the device. In situations where quick response is paramount, an operator may transport the mobile separator device 100 quickly to the selected working site, unpack the interior sump by removing the filter component(s) 20 and placing the device in the working position. Placing the device in the working position may include couplably engaging the filter component(s) 20 with corresponding filtration port(s) 15, and placing the bracket assembly 30 into an extended position to support the filter component(s) 20 and stabilize the device 100 (See FIG. 3).

Filter component(s) 20 include an adsorbing/absorbing filtration media capable of selective removal of hydrocarbon-based contaminates from the contaminated liquid source, while allowing egress of other certain liquids, such as water, to an exterior of the device 100 as a purified liquid source. The filter component may comprise a Petro-Pipe™ as manufactured by Solidifications Products International, Inc. of North Branford, Connecticut, United States. In some embodiments, the filtration media may chemically harden after complete saturation of the media by the hydrocarbon-based contaminant, preventing further liquid flow through the filter component.

Filtration port(s) 15 deliver contaminated liquid within the interior sump 23 to the filter component 20. The filtration port(s) may include a valve 18, which may be a ball-valve, gate valve, and the like to permit or restrict liquid flow through the filtration port as necessary. This is advantageous in situations where the adsorbing/absorbing filtration media of the filter component(s) 20 has chemically hardened, preventing contaminated or purified liquid from egressing to the vessel housing exterior. In such situations, valve 18 may be placed in a position to restrict liquid flow through filtration port 15 so that the filter component 20 may be removed from the assembly and replaced as needed to ensure proper filtering flow from the interior sump 23. In such embodiments, the mechanical connection between the filtration port 15 and filter component 20 may comprise a removably attachable filter interconnect, such as a cam-locking fitting (not shown) to enable quick, in-situ replacement of the replaceable filter component during operation, though other mechanical connections, such as screw-lock fittings and the like, are not meant to be precluded.

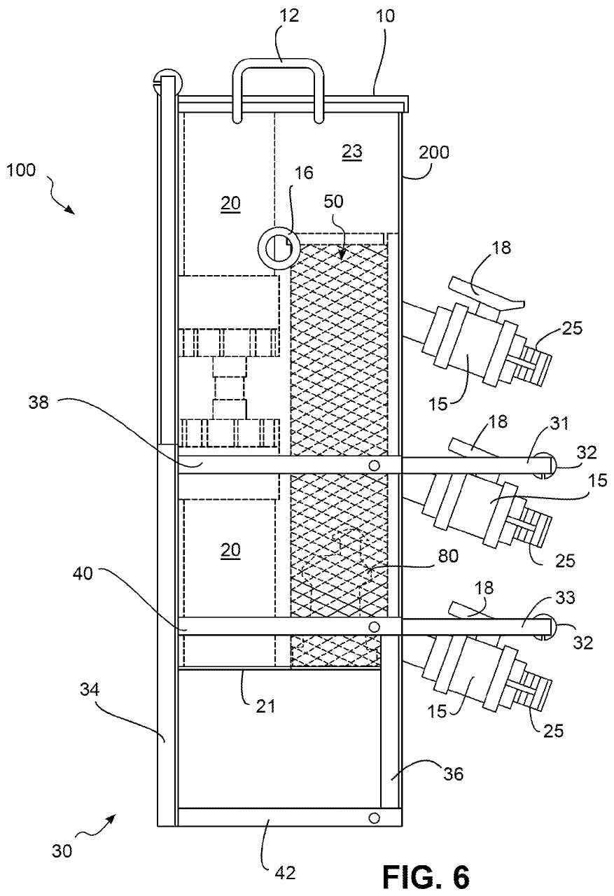

FIG. 6 depicts a side elevation view of a mobile liquid contaminate separator according to one embodiment of the present invention, with internal features shown in broken lines. The interior sump 23 may comprise a debris housing 50 on the interior of the vessel housing sidewall 2, 4, 6, 8 which opposes filtration port(s) 15, formed of vertical sidewalls 51, 52, 53, 54 extending from the vessel housing base 21 and encapsulating the filtration port(s) 15 within the interior sump 23. The debris housing sidewalls 51, 52, 53, 54 may be constructed of a grated material such as diamond grating, a pre-filter grate, mesh, and the like to prevent dirt or debris from entering the housing 50, while maintaining fluid communication between the interior sump 23 and the filtration port(s) 15. The debris housing 50 may further comprise a removable lid 55 to permit access to the debris housing interior. The debris housing interior may include at least one dirt and debris filter (not shown) for the capture of smaller particles and debris not ensnared by the housing sidewalls 51, 52, 53, 54. A pump 80 (shown in broken line behind the debris housing sidewall) may also be provided within the debris housing interior to establish a siphon for transport of the contaminated liquid source, though other methods of establishing a siphon with a contaminated liquid source at a low laying location are not meant to be precluded.

Filtration port(s) 15 include a removably attachable filter interconnect 25 to enable quick replacement of the replaceable filter component 20 (shown in FIG. 6 in a stowed position within the interior sump 23) during operation, though other mechanical connections, such as screw-lock fittings and the like, are not meant to be precluded. Filtration port(s) 15 may be oriented at an angle below horizontal to facilitate gravity flow of liquid egressing the filter component(s) 20 (e.g., 15-degrees to 25-degrees below horizontal).

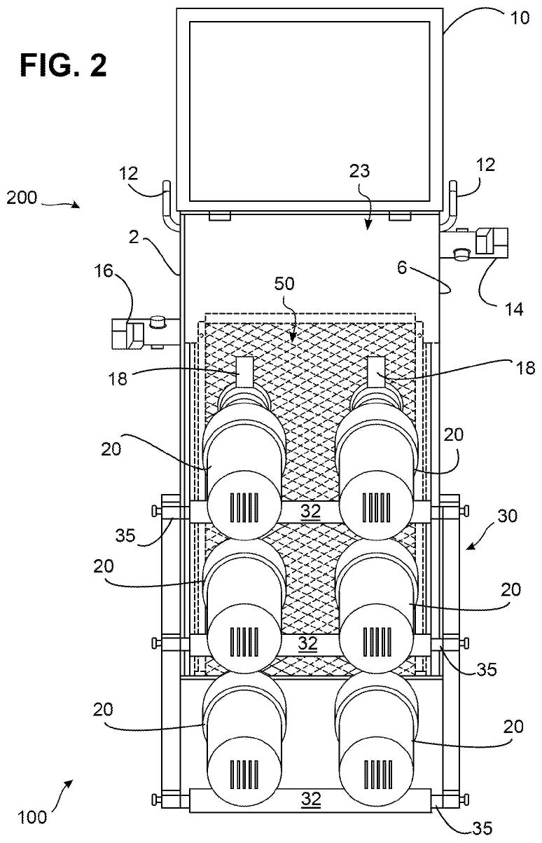

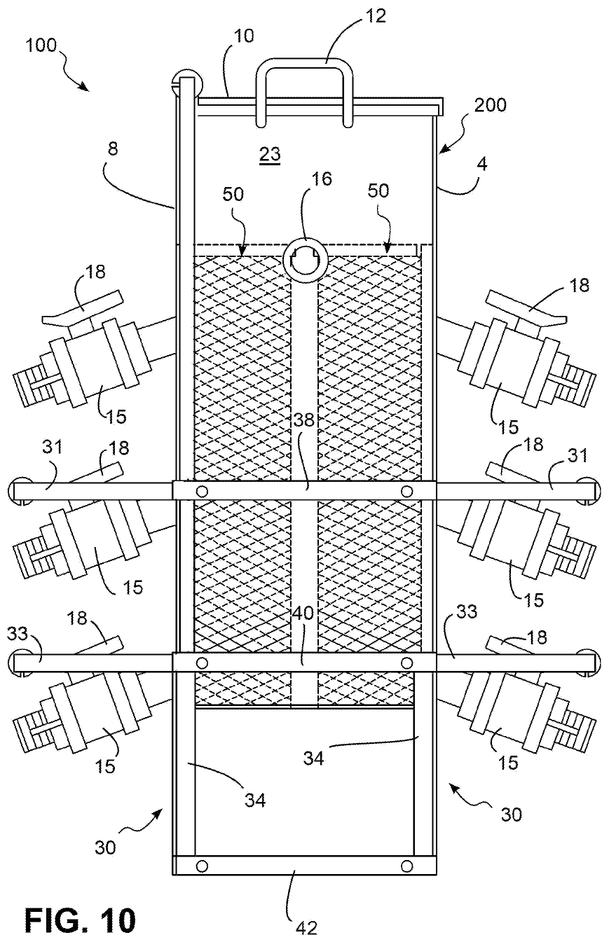

In the exemplary views of FIGS. 2-5, 8 and 9, vessel housing 200 includes six (6) filtration ports 15, each in communication with a removable filter component 20. As depicted, the filtration ports/filter components of the device 100 are arranged in a 3-row by 2-column matrix on a sidewall surface of the vessel housing 200. The number (and placement) of filtration ports/filter components will depend on the specific application and necessary flow rate of contaminated liquid entering the interior sump, but may include as little as one or as many as ten (or even more) filtration ports/filter components. With additional reference to FIG. 10, the filtration port(s)/filter component(s) may be located on any exposed sidewall of the vessel housing 200 to provide selective filtration of hydrocarbon-based contaminates from a contaminated liquid source, and may include a plurality of debris housings 50.

In cases where the contaminated liquid source may be particularly saturated with hydrocarbon-based contaminates such that the rate the adsorbing/absorbing filtration media chemically hardens is greater than the rate of replacement for the filter component(s) 20 of the device, the liquid level within the interior sump 23 will start to rise. In order to meet the replacement demand and prevent migration for the contaminated liquid source to the exterior of the vessel housing 200, liquid return port 16 will redirect and discharge surplus contaminated liquid back into the low lying location, and can therefore be recycled through the device 100. In such instances, replacement of the filter component(s) 20 can be facilitated utilizing valves 18. In some embodiments, such as those depicted in FIG. 3, vessel housing may include a non-opaque (i.e., transparent or translucent) liquid level indicator 90 to ensure proper working operations of the mobile separator device 100 after lid portion 10 has been closed, establishing a pressurized environment within the interior sump 23. Further liquid inlet port 14 may include a ball-valve, gate valve, and the like to selectively regulate the flow of contaminated liquid entering the interior sump 23, further mitigating the risk of a contaminated fluid overflow within the vessel housing 200.

Vessel housing 200 is formed having a base 21 with vertically upstanding sidewalls 2, 4, 6, 8 forming an interior sump portion 23. The vessel housing may include a lid portion 10 hingedly secured to the vessel housing 200, to encapsulate interior sump portion 23. Lid portion 10 may include sealing elements such as rubber gaskets and the like to aid in establishing a pressurized environment within the interior sump 23. One or more handles 12 may be included on one or more of the vessel housing's upstanding sidewalls 2, 4, 6, 8. The vessel housing 200 may comprise a bracket assembly 30 for elevating the vessel housing 200, and may be secured proximate the base 21. Bracket assembly 30 may include one or more telescoping bracket subassemblies 31, 33, 35, and is described in further detail below.

The mobile separator device 100 may be sized to provide efficient assembly while featuring a compact design for ease of storage and mobility. The device may be sized to accommodate a pump-through flow rate of approximately 20-gallons per minute, and may be constructed of a lightweight material comprising metal(s), metallic alloy(s), polymer(s) or the like which would provide structural rigidity while ensuring transportation of the device 100 via labor force (e.g., workforce, human resources and the like) without need of a lifting mechanism to load/unload the device from a stored locale to a selected working site proximate the low laying location.

Bracket assembly 30 comprises a plurality of vertical and horizontal framework members 34, 36, 38, 40, 42 which may surround at least a portion of the one or more vessel housing sidewalls 2, 4, 6, 8 proximate the vessel housing base 21, providing an elevated platform for the mobile separator device 100. As depicted in FIGS. 3-5 and 7-9, bracket assembly 30 includes vertical brace member(s) 34 extending between horizontal framework(s) platform member(s) 42 and horizontal support members 40 and 38. Vertical brace member(s) 34 is coupled to an end portion of the horizontal framework members 38, 40, 42, and the bracket assembly may comprise additional vertical bracing element(s) 36 coupled with the horizontal framework members 38, 40, 42 at an opposing end. As depicted in FIGS. 1, 3, and 6-8, vertical bracing element(s) 36 are coupled to platform member 42 and support member 40 to provide additional support and overall rigidity of the bracket assembly 30. Additional vertical bracing elements may be included as desired and as needed to provide sufficient rigidity to the mobile separator device 100 during working operations.

The vertical and horizontal framework members 34, 36, 38, 40, 42 may be constructed of a material comprising tubular fiberglass-reinforced polymer, hot-dipped galvanized steel, stainless steel, and the like. While the tubes preferably have a square cross-section, other tubular shapes are not to be precluded. The horizontal framework members 38, 40, 42 may include a telescoping bracket subassembly 31, 33, 35 received within at least a portion of the horizontal framework member(s). Telescoping bracket subassembly 31, 33, 35 may be constructed to surround one or more vessel housing sidewalls 2, 4, 6, 8. As depicted in FIGS. 1-5, 7 and 9, telescoping bracket subassembly 31, 33, 35 comprises a U-shaped telescoping element extendable away from the vessel housing 100 to surround vessel housing sidewall 4 which includes the filtration port(s) 15 and filter component(s) 20, and further surrounds a portion of sidewalls 2,4, though other constructions and configurations of the telescoping bracket subassembly 31, 33, 35 are not meant to be precluded. Telescoping bracket subassembly 31, 33, 35 may be sized to form a transition or clearance engagement with the interior of the horizontal framework member(s) 38, 40, 42 the subassembly is received within.

Telescoping bracket subassembly 31, 33, 35 is moveable between a retracted position wherein a length portion of the subassembly is within an interior of the horizontal framework member(s) to an extended position wherein the length portion of the extension member is exterior to the horizontal framework member(s). In the extended position, telescoping bracket subassembly 31, 33, 35 is cantilevered from the mobile separator device 100, thereby altering the device center of mass to stabilize the device and prevent toppling during operations. This is particularly advantageous after attachment of the removeable filter component(s) 20 and during replacement of the filter component(s) 20 during operations, which would otherwise alter the device's center of gravity.

At least a portion of telescoping bracket subassembly 31, 33, 35 may comprise a resilient grasping element 32 constructed of a deformable or elastic material such as rubber, foam, and the like. Grasping element 32 yields additional tactile grip to an operator to facilitate movement of the telescoping bracket subassembly 31, 33, 35 between the extended/retracted positions. In some embodiments and depending on angled placement of the filtration port(s) 15, grasping element 32 may provide a biasing surface to maintain filter component(s) 20 in a proper alignment position and facilitate ease of replacement.

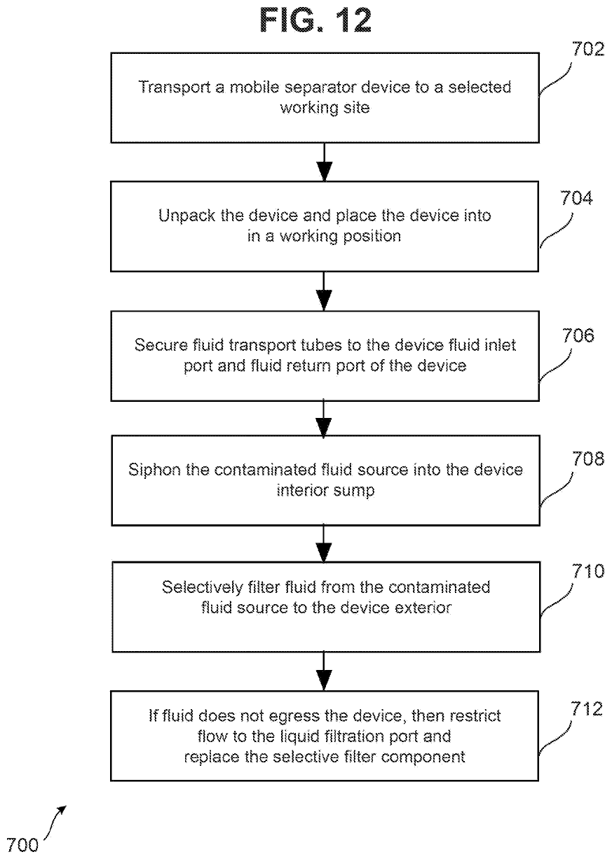

In some embodiments, backet assembly 30 may include wheeled element(s) 72 (See FIG. 12) which may be tracks, wheels, casters and the to provide additional mobility of the mobile separator device 100.

FIG. 10 depicts a perspective view of a mobile liquid contaminate separator according to one embodiment of the present invention, with internal features shown in broken lines. Vessel housing 200 may be designed for liquid treatment operations on a plurality of vessel housing surfaces. As shown, opposing vessel housing sidewalls 4 and 8 include a bracket assembly 30 with telescoping bracket subassemblies, as well as filtration port(s) 15 and filter component(s) 20 in communication with a debris housing 50. In such embodiments, additional flow capacity may be realized without sacrificing overall mobility of the device 100.

FIGS. 1, 6 and 7 depict the mobile separator device 100 in a stowed position. Interior sump 23 may be sized to allow placement of the filter component(s) 20 therein, further increasing the overall modularity and mobility of the device. Thus, in situations where quick response is paramount, an operator may transport the mobile separator device 100 quickly to the selected working site while ensuring the ability/capacity for the removal of hydrocarbon-based contaminates from a contaminated liquid source due to the plurality of pre-loaded filter components 20 within the interior sump 23. When placed in the stowed position, the mobile separator device 100 requires a significantly decreased footprint, allowing a small, compact device which can be used in situations to employ a rapid response to low laying locations. Further, the device can be utilized in locations which would otherwise be difficult to position larger equipment.

FIG. 12 depicts a flow diagram of an example method for the removal of hydrocarbon-based contaminates from a contaminated liquid source according to one embodiment of the present invention. The method 700 includes transporting a mobile separator device according to an embodiment of the present invention to a selected working site proximate a contaminated liquid source (block 702). The device may then be unpacked by the removal of filter component(s) from the interior sump, and placed into a working position (block 704). In the working position, a bracket assembly may be placed into an extended position, stabilizing the device, and the filter component(s) may be coupled to the device's filtration port(s). Liquid transport tubes are secured to the liquid inlet port and liquid return port of the device, enabling fluid communication with the contaminated liquid source (block 706). Upon establishing a siphoning action within the liquid transport tube, the contaminated liquid source will ingress the device sump (block 708). As the volume of contaminated liquid increases within the interior sump, contaminated liquid begins to communicate with the vessel housing filtration port(s) and/or filter component(s) for selective liquid removal of the contaminated liquid source to the device exterior (block 710).

In some embodiments, the bracket assembly may support the filter component(s) when placed into the extended position. If fluid no longer egresses the device exterior, the method may further include preventing flow through the filtration port, disengaging the filter component may be from the filtration port, and coupling a new filter component to the filtration port (block 712). A liquid return port may prevent overflow of the contaminated liquid source to the selected working site.

Thus, the present invention provides one or more of the following advantages: an apparatus for and method of treating hydrocarbon contaminated liquid sources which can be readily moved without lifting equipment; a mobile liquid treatment device which can be readily stored when not in use; an liquid treatment device which is readily transported and modular to encompass small working/stored footprints; and an apparatus for and method of treating hydrocarbon contaminated liquid sources which is located in a low laying location that can be done efficiently and expeditiously.

While the present invention has been particularly described, in conjunction with one or more specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A mobile liquid separator device for removing hydrocarbon-based contaminates from a contaminated liquid source, said device comprising:
a vessel housing comprising a base with vertically upstanding sidewalls forming an interior sump, a liquid inlet port, a liquid return port, and a filtration port;
said liquid return port, said filtration port, and said liquid inlet port disposed on at least one of the vertically upstanding sidewalls and in communication with the interior sump;
a removable filter component for couplable engagement with the filtration port, the removable filter component housing an adsorbing/absorbing filtration media capable of removing hydrocarbon-based contaminates from a contaminated liquid source, and allowing egress of a purified portion of the contaminated liquid source to the exterior of the device; and
a bracket assembly coupled to the vessel housing proximate the base including a telescoping bracket subassembly moveable between a retracted position wherein a length portion of the telescoping bracket subassembly is within an interior of the bracket assembly to an extended position wherein the length portion of the telescoping bracket subassembly is exterior to the bracket assembly and cantilevered from the vessel housing.

2. The device of claim 1, further comprising a lid portion and at least one handle lifting operations of the device.

3. The device of claim 1, wherein the filtration port comprises a plurality of filtration ports and wherein the removeable filter component comprises a plurality of removable filter components, each of the plurality of removable filter components communication with one of the plurality of filtration ports.

4. The device of claim 1, wherein the filtration port includes a valve.

5. The device of claim 1, further including a removably attachable filter interconnect, the removably attachable filter interconnect for removeable engagement with the filter component.

6. The device of claim 1, wherein the interior sump includes debris housing in fluid communication with the filtration port.

7. The device of claim 6, wherein the debris housing includes a pump capable of establishing a siphon for transport of a contaminated liquid into the interior sump.

8. The device of claim 1, wherein the filtration port is oriented at an angle of 15-degrees to 25-degrees below horizontal to facilitate gravity flow of liquid egressing the interior sump.

9. The device of claim 3, wherein the plurality of filtration ports are arranged in a 3-row by 2-column matrix on a sidewall surface of the vessel housing.

10. The device of claim 1, wherein the vessel housing includes a non-opaque liquid level indicator.

11. The device of claim 1, wherein the bracket assembly includes a plurality of telescoping bracket subassemblies, each of the plurality of telescoping bracket subassemblies supporting a plurality of filter components when placed in the extended position.

12. The device of claim 1, wherein the bracket assembly comprises a plurality of vertical and horizontal framework providing an elevated platform for the vessel housing.

13. The device of claim 1, wherein the telescoping bracket subassembly includes resilient grasping element.

14. The device of claim 1, further including a liquid transport tube secured to the liquid inlet port and the liquid return port, the liquid transport tube in fluid communication with a hydrocarbon contaminated liquid source in a location below the vessel housing.

15. The device of claim 1, including a plurality of bracket assemblies coupled to the vessel housing proximate the base.

16. A method of removing hydrocarbon-based contaminates from a contaminated liquid source, the method comprising the steps of:
transporting a mobile separator device from a stowed location to a selected work site proximate a contaminated liquid source;
securing liquid transport tubes to a liquid inlet port and a liquid return port of the mobile separator device to establish fluid communication of the contaminated liquid source with an interior sump of the mobile separator device;
establishing a siphon action within the liquid transport tube such that the contaminated liquid source ingresses the interior sump; and
establishing fluid communication with a filtration port and/or a removable filter component of the mobile separator device for selective liquid removal of the contaminated liquid source to the mobile separator device exterior.

17. The method of claim 16, further comprising the steps of:
moving a telescoping bracket subassembly of a bracket assembly coupled to the mobile separator device from a retracted position wherein a length portion of the telescoping bracket subassembly is within an interior of the bracket assembly to an extended position wherein the length portion of the telescoping bracket subassembly is exterior to the bracket assembly and cantilevered from the mobile separator device.

18. The method of claim 16, further comprising the steps of:
unpacking the device such that the removable filter component are removed from the interior sump; and
engaging the removable filter component to the filtration port via a removably attachable filter interconnect.

19. The method of claim 18, further comprising the steps of:
preventing the ingress of liquid to the filtration port;
disengaging the filter component from the filtration port;
securing a second removable filter component to the filtration port via the removably attachable filter interconnect; and
allowing the ingress of liquid to the filtration port.

20. The method of claim 16, wherein the steps of “transporting a mobile separator device from a stowed location to a selected work site proximate a contaminated liquid source” may be performed using labor force.

21. The method of claim 16, wherein the removable filter component houses an adsorbing/absorbing filtration media capable of removing hydrocarbon-based contaminates from the contaminated liquid source, and allows the egress of a purified portion of the contaminated liquid source to the mobile separator device exterior.

22. The method of claim 16, further comprising the steps of:
unpacking the device such that a plurality of removable filter components are removed from the interior sump;
engaging each of the removable filter components with a removably attachable filter interconnect on each of a plurality of filtration ports; and
placing the device into a working position wherein a plurality of telescoping bracket subassemblies of a bracket assembly are cantilevered from the mobile separator device such that the separator device is stabilized and each of the plurality of removable filter components is supported by the bracket assembly.

23. The method of claim 16, wherein if liquid does not exit the filter component to the mobile separator device exterior, the method further comprises the steps of:
restricting fluid communication between the filtration port and the filter component via a valve of the filtration port;
uncoupling the filter component from a removably attachable filter interconnect of the filtration port;
engaging a second removable filter component to the filtration port; and
establishing fluid communication between the filtration port and the second filter component.
